(19) United States
(12) Patent Application Publication
(10) Pub. No.: US 2023/0179718 A1
(43) Pub. Date: Jun. 8, 2023

(54) IMAGING DEVICE OPERATIONS BASED ON BUSINESS MODELS

(71) Applicant: Hewlett-Packard Development Company, L.P., Spring, TX (US)

(72) Inventors: Phillip A. Mccoog, Vancouver, WA (US); Marc Yousey, Vancouver, WA (US); Paul L. Jeran, Boise, ID (US); Joseph Yang, Cypress, CA (US)

(73) Assignee: Hewlett-Packard Development Company, L.P., Spring, TX (US)

(21) Appl. No.: 17/921,124

(22) PCT Filed: May 13, 2020
(86) PCT No.: PCT/US2020/032613

§ 371 Date: Oct. 25, 2022

(51) Int. Cl. G06K 15/02

(52) U.S. Cl. CPC G06K 15/02; G06K 15/1805

(57) ABSTRACT

In some examples, an imaging device can include a processing resource and a memory resource storing instructions to cause the processing resource to receive an operating parameter corresponding to a business model, configure the imaging device based on the received operating parameter corresponding to the business model, and operate the imaging device according to the received operating parameter.

### BACKGROUND

Imaging systems, such as printers, copiers, etc., may be used to form markings on a physical medium, such as text, images, etc. In some examples, imaging systems may form markings on the physical medium by performing an imaging device operation. An imaging device operation can include forming markings such as text and/or images by transferring a print material (e.g., ink, toner, etc.) to the physical medium, scanning a physical medium, copying a physical medium, and/or faxing a physical medium, among other types of imaging device operations.

### BRIEF DESCRIPTION OF THE DRAWINGS

FIG. 1 is an example system of an imaging device and a remote server for imaging device operations based on business models consistent with the disclosure.

FIG. 2 is an example system of a remote server and a plurality of imaging devices for imaging device operations based on business models consistent with the disclosure.

FIG. 3 is a diagram of an example imaging device for imaging device operations based on business models consistent with the disclosure.

FIG. 4 is a block diagram of an example system for imaging device operations based on business models consistent with the disclosure.

### DETAILED DESCRIPTION

Imaging devices may include a supply of a print material. As used herein, the term “print material” refers to a substance which can be transported through and/or utilized by an imaging device. In some examples, print material can be, for instance, a material that when applied to a medium, can form representation(s) (e.g., text, images models, etc.) on the medium during an imaging device operation (e.g., a print job, scan job, a copy job, a facsimile job, etc.). Print material may include ink, toner, etc.

The print material can be deposited onto a physical medium during certain imaging device operations. As used herein, the term “imaging device” refers to any hardware device with functionalities to physically produce representation(s) (e.g., text, images, models, etc.) on the medium. In some examples, a “medium” may include paper, photopolymers, plastics, composite, metal, wood, or the like.

An imaging device may perform imaging device operations according to certain parameters, which may correspond to a particular business model designed for the imaging device. As used herein, the term “business model” refers to a method of operation of an imaging device according to a set of standards that can dictate limits on imaging device functionality and/or imaging device supplies usage. The set of standards can be set according to monetary, contractual, supply, and/or other types of considerations. For example, a particular business model of an imaging device may dictate that the imaging device can perform a predetermined amount of imaging device operations (e.g., print a predetermined amount of pages) before a fee is to be paid for additional imaging device operations to be available, Business models may include supply subscriptions, supply loyalty, page block, automatic fulfillment, device lease, page subscriptions, advanced scanning, among other types of business models, as is further described in connection with FIG. 1. Business models can govern any operations of the imaging device. For example, business models can govern print jobs, scanning/copying, faxing, and/or any other imaging device operations, as is further described herein.

In some examples, the imaging device can perform a print job. As used herein, the term “print job” refers to forming markings on a physical medium by transferring a print material to the physical medium. For example, an imaging device can form text on a physical medium.

In some examples, the imaging device can perform a scan job. As used herein, the term “scan job” refers to optically scanning images, printed text, handwriting, and/or other objects and converting the scan to a digital image. For example, an imaging device can optically scan text from a physical medium and generate a corresponding digital image of the physical medium including the text. In some examples, the scanned physical medium including the text may be printed via a print job.

In some examples, the imaging device can perform a copy job. As used herein, the term “copy job” refers to optically scanning images, printed text, handwriting, and/or other objects and forming markings of the scan to a different physical medium. For example, an imaging device can optically scan text from a physical medium and form corresponding markings for the scanned text on another physical medium.

In some examples, the imaging device can perform a facsimile job. As used herein, the term “facsimile job” refers to optically scanning images, printed text, handwriting, and/or other objects and telephonically transmitting the optical scan to another telephone number connected to another output device. For example, an imaging device can optically scan text from a physical medium and telephonically transmit the optical scan to another output device (e.g., a facsimile machine) that can output the received optical scan during a print job.

Although imaging device operations are described above as including a print job, a scan job, a copy job, and/or a facsimile job (e.g., a fax job), examples of the disclosure are not so limited. For example, imaging device operations can include any other type of operation performed by an imaging device.

A business model may be included in the imaging device at manufacture and agreed to by a user when acquiring (e.g., purchasing, leasing, etc.) the imaging device, among other examples. For instance, a user may agree to lease an imaging device from a vendor for a monthly fee. The business model can have operating parameters associated with it that can cause the imaging device to operate according to the business model. In some examples, operating parameters may be included in the firmware of the imaging device prior to the user taking possession of the imaging device.

As operating parameters may be included in the firmware of the imaging device, it can be difficult to change the imaging device to a different business model. For example, in order to change the business model, a firmware update would have to be performed on the imaging device. However, firmware updates may be a long and difficult task to generate the firmware update, test the firmware update, and push the firmware update. Further, some users of the imaging device may lack technical expertise to implement a firmware update.

Typically when a new business model is targeted for entry into the market, introduction of new hardware or firmware updates to existing hardware has to be performed. It may take long periods of time for imaging devices having the new business model firmware or hardware to enter and saturate the marketplace, which may lead to losses in revenue.

Imaging device operations based on business models, according to the disclosure, can allow for business models to be modified, updated, and/or changed on imaging devices currently in operation in the marketplace by transmitting operating parameters to imaging devices that correspond to various business models. The operating parameter transmitted to an imaging device can allow the imaging device to configure itself for operation according to the business model corresponding to the operating parameter. Configuration of the imaging device according to an operating parameter can allow for flexibility of how an imaging device operates without changing the imaging device for a different imaging device and/or imaging device supply changes, allowing for future business model innovation as well as greater user choice when selecting an imaging device for personal and/or business use.

FIG. 1 is an example system 100 of an imaging device 102 and a remote server 110 for imaging device operations based on business models consistent with the disclosure. The system 100 can include an imaging device 102, a remote server 110, and an external server 112. The imaging device 102 can include an operating parameter 104-1, a display device 108, and a user interface 106. The remote server 110 can include operating parameters 104-2, 104-3, 104-N.

As illustrated in FIG. 1, the imaging device 102 can receive an operating parameter 104-1. As used herein, the term “operating parameter” refers to a rule that can cause an imaging device to operate in a particular way. For example, the operating parameter 104-1 can cause the imaging device 102 to operate according to a particular protocol. The protocol can be, for example, a business model. In other words, the operating parameter 104-1 can correspond to a particular business model to cause the imaging device 102 to operate according to the particular business model, as is further described herein.

Although the imaging device 102 is illustrated in FIG. 1 as including a single operating parameter 104-1 corresponding to a particular business model, examples of the disclosure are not so limited. For example, there may be more than one operating parameter associated with a particular business model, and the more than one operating parameter (e.g., two or more) can be received by the imaging device 102.

The imaging device 102 can receive the operating parameter 104-1 from the remote server 110. The imaging device 102 can receive the operating parameter 104-1 via a network relationship with the remote server 110. The network relationship can be a wired or wireless connection.

The wired or wireless network connection can be a network relationship that connects the imaging device 102 with the remote server 110. Examples of such a network relationship can include a local area network (LAN), wide area network (WAN), personal area network (PAN), a distributed computing environment (e.g., a cloud computing environment), storage area network (SAN), Metropolitan area network (MAN), a cellular communications network, Long Term Evolution (LTE), visible light communication (VLC), Bluetooth, Worldwide Interoperability for Microwave Access (WiMAX), infrared (IR) communication, Public Switched Telephone Network (PSTN), radio waves, and/or the Internet, among other types of network relationships.

The operating parameter 104-1 may correspond to a particular business model. Examples of business models can include supply subscriptions, supply loyalty, page block, automatic fulfillment, device lease, page subscriptions, print quality enhancements, among other types of business models, as is further described herein. The received operating parameter 104-1 can be, for example, a software package for use by the imaging device 102.

As described above, the operating parameter 104-1 may correspond to a supply subscription business model. As used herein, the term “supply subscription business model” refers to a method of operation of an imaging device in which a recurring fee is charged to a user to access a product or service. For example, the supply subscription business model may dictate a monetary fee charged on a recurring basis (e.g., daily, monthly, yearly, etc.) in order for imaging device operations to be enabled by the imaging device 102. In some examples, the recurring fee may allow for activation of a print material supply (e.g., activation of the ink), activation of the imaging device 102 itself, etc. In other words, payment of the recurring fee may allow for the imaging device 102 to perform imaging device operations, and failure to pay the recurring fee may result in the imaging device 102 being prevented from performing imaging device operations.

In some examples, the operating parameter 104-1 may correspond to a supply loyalty business model. As used herein, the term “supply loyalty business model” refers to a method of operation of an imaging device in which a user receives special benefits by using one particular brand or type of print supplies from a manufacturer and/or supplier. The special benefits may be monetary and/or functional in nature. For example, a user may receive a cash reward (e.g., a check, gift card, etc.) from a manufacturer for purchasing a particular amount of print supplies from one brand.

In some examples, the operating parameter 104-1 may correspond to a page block business model. As used herein, the term “page block business model” refers to a method of operation of an imaging device in which a fee is charged to a user for an amount (e.g., a block) of pages for imaging device operations. For example, the page block business model may dictate a monetary fee per amount of printable pages. For instance, a fee (e.g., $100) may be charged to a user for a block of 500 pages of imaging device operations, and once 500 pages have been exhausted during imaging device operations, the imaging device 102 may be prevented from performing further imaging device operations until an additional block of pages are purchased.

In some examples, the operating parameter 104-1 may correspond to an automatic fulfillment business model. As used herein, the term “automatic fulfilment business model” refers to a method of operation of an imaging device in which imaging device operations are performed while imaging device supplies (e.g., print media, print material, etc.) are automatically fulfilled, for a fee, once a particular supply life state is reached. In some examples, the automatic fulfillment business model may automatically resupply toner cartridges for a monetary fee when an amount of toner falls below a predefined threshold value (e.g., less than 20% left, depleted, etc.). In some examples, the automatic fulfillment business model may automatically resupply printing paper for a monetary fee when an amount of printing paper falls below a predefined threshold value.

In some examples, the operating parameter 104-1 may correspond to a device lease business model. As used herein, the term “device lease business model” refers to a method of operation of an imaging device in which a user pays a fee for a specified period for use of the imaging device for the specified period. For example, a user may pay a monthly monetary fee for use of the imaging device 102, and failure to pay the monthly fee may result in the imaging device 102 being prevented from functioning as intended (e.g., from performing some or all imaging device operations).

In some examples, the operating parameter 104-1 may correspond to a page subscription business model. As used herein, the term “page subscription business model” refers to a method of operation of an imaging device in which a user pays a fee per page printed. For example, a user may pay a monetary fee for every page of print media printed using the imaging device 102.

Although business models including supply subscription, supply loyalty, page block, automatic fulfillment, device lease, and page subscription are described above, examples of the disclosure are not so limited. For example, operating parameters 104 can correspond to any other type of business model. Additionally, the type of business model can be agnostic to imaging device manufacturer and/or models.

As described above, the imaging device 102 can receive an operating parameter 104-1 that can cause the imaging device 102 to operate according to a business model associated with the operating parameter 104-1. For example, the operating parameter 104-1 can cause the imaging device 102 to operate according to a device lease business model, as is further described herein.

The imaging device 102 can configure itself based on the received operating parameter 104-1 corresponding to the business model. For example, the imaging device 102 can adapt its operation so that the imaging device 102 operates when a monthly monetary fee is paid when the operating parameter 104-1 corresponds to a device lease business model. The imaging device 102 can operate according to the received operating parameter 104-1 by performing an imaging device operation and/or generating a user interface based on the operating parameter 104-1 corresponding to the business model, as is further described herein.

In some examples, the imaging device 102 can operate by performing an imaging device operation based on the operating parameter 104-1 corresponding to the business model. For example, the operating parameter 104-1 can correspond to a page block business model, and the imaging device 102 can perform an imaging device operation in response to the imaging device 102 being in compliance with the page block business model (e.g., a fee has been paid for an amount of pages for imaging device operations and the amount of pages has not been exhausted). For instance, the imaging device may be configured to operate according to the page block business model by operating parameter 104-1 where a fee has been paid for 100 pages of imaging device operations. The imaging device 102 can perform an imaging device operation in response to an amount of the 100 pages still being available for operations (e.g., printing, scanning, copying, faxing, etc.) or, if the 100 pages has been exhausted, a fee being paid for an additional amount of pages to be printed, scanned, copied, faxed, etc.

The remote server 110 can determine whether the imaging device 102 is in compliance with the business model of operating parameter 104-1. Continuing with the example above, the remote server 110 can determine an amount of pages from the purchased block of pages are available for imaging device operations. For example, the remote server 110 can determine there are 50 pages remaining for printing and in response, the imaging device 102 can perform a print job. As another example, the remote server 110 can determine there are 50 pages left for scanning and in response, the imaging device 102 can perform a scan job. As a further example, the remote server 110 can determine there are 30 pages left for copying a 50 page document and in response, the imaging device 102 can be prevented from performing the copying job. In an example in which an imaging device operation may exceed the amount of pages remaining, the display device 108 can display a contextually accurate message in line with the particular business model of the operating parameter 104-1 via the user interface 106, as is further described herein.

The remote server 110 can determine compliance with the business model of the operating parameter 104-1 at a predetermined frequency. For example, if the operating parameter 104-1 corresponds to a page block business model, the remote server 110 can determine compliance when an imaging device operation for the imaging device 102 is requested by the user. As another example, if the operating parameter 104-1 corresponds to a device lease business model, the remote server 110 may determine compliance according to a recurring schedule, which can comply with the lease period (e.g., monthly), etc.

The imaging device 102 can include a display device 108. As used herein, the term “display device” refers to an output device that includes a display area that displays information provided by an electrical signal in a visual and/or tactile form. As used herein, the term “display area” refers to an area of a display device that displays information. For example, the imaging device 102 can include a display device having a display area that can display information such as text, videos, and/or images, as a result of an electrical signal provided to the display from the imaging device 102.

In some examples, the display device 108 can display a user interface 106 on the display area of the display device 108. As used herein, the term “user interface” refers to an interface that can provide information to and/or receive information from a user. The user interface can be any interface that can provide information to a user. For instance, the user interface can be a graphical user interface, an alarm (e.g., audible or visible), etc., as is further described herein. In some examples, the user interface 106 can be a graphical user interface that can display information to a user of the imaging device 102 via a display area of a display device. In some examples, the user interface 106 can be a light or series of lights, which may be color coded based on the operating parameter 104-1. In some examples, the user interface 106 can be an audible sound emitted by an audio output device.

In some examples, the imaging device 102 can generate the user interface 106 as a graphical user interface based on the operating parameter 104-1 corresponding to the business model. The user interface 106 can be displayed by a display area of the display device 108. For example, the operating parameter 104-1 may correspond to a page block business model, and a user may request an imaging device operation to be performed but the imaging device operation exceeds an amount of pages remaining in the block of pages; the imaging device 102 can, accordingly, generate the user interface 106 displayed by the display device 108 that illustrates to a user that the imaging device operation exceeds the amount of pages remaining in the block of pages and that additional block of pages should be purchased to perform the requested imaging device operation. As another example, the operating parameter 104-1 may correspond to a device lease business model, and a user may request an imaging device operation to be performed but the monetary fee for the specified period has not been paid; the imaging device 102 can generate the user interface 106 displayed by the display device 108 that illustrates to a user that the monetary fee for the specified period should be paid to perform the requested imaging device operation. As a further example, the operating parameter 104-1 may correspond to an automatic fulfillment business model, and a user may request an imaging device operation to be performed which may cause an ink supply of the imaging device 102 to fall below a predefined threshold value; the imaging device 102 can generate the user interface 106 displayed by the display 108 that illustrates to a user that a resupply order has automatically been submitted to refill the ink supply of the imaging device 102.

In some examples, the imaging device 102 can generate the user interface 106 as a light or series of lights, which may be color coded. For example, the operating parameter 104-1 may correspond to a page block business model, and a user may request an imaging device operation to be performed but the imaging device operation exceeds an amount of pages remaining in the block of pages; the imaging device 102 can, accordingly, cause a light or a series of lights to be activated (e.g., lit up in a red or other color) to indicate to a user that the imaging device operation exceeds the amount of pages remaining in the block of pages and that additional block of pages should be purchased to perform the requested imaging device operation.

In some examples, the imaging device 102 can generate the user interface 106 as an audible sound emitted by an audio output device. For example, the operating parameter 104-1 may correspond to an automatic fulfillment business model, and a user may request an imaging device operation to be performed which may cause an ink supply of the imaging device 102 to fall below a predefined threshold value; the imaging device 102 can audible indicate (e.g., via a pre-recorded message) via an audio output device (e.g., a speaker) to a user that a resupply order has automatically been submitted to refill the ink supply of the imaging device 102.

The user interface 106 can include settings of the imaging device 102. As used herein, the term “setting” refers to an option for adjustment of a function of the imaging device 102. For example, the user interface 106 can display settings of the imaging device 102, such as print job settings (e.g., toggling of color printing, duplex, finishing settings, compression, etc.), scan settings (e.g., toggling of color scanning, finishing settings, image quality, file output type, etc.), copy settings (e.g., pages to copy, toggling of color copying, duplex output, finishing settings, image quality, etc.), and/or facsimile settings (e.g., destination address, finishing settings, etc.).

The user interface 106 can include error reporting of the imaging device 102. For example, in response to an error occurring in the imaging device 102, the user interface 106 can report errors to a user of the imaging device 102. For instance, if a paper jam occurs in the imaging device 102 during an imaging device operation, the user interface 106 can report the paper jam to a user of the imaging device 102. In some examples, the error reporting of the imaging device 102 can include an indication for further information about the error. For example, if the paper jam occurs in the imaging device 102 during an imaging device operation, the user interface 106 can provide a uniform resource locator (URL) a user can follow to get more information about the state of the imaging device 102.

The imaging device 102 can operate by performing a self-test print job. As used herein, the term “self-test print job” refers to a testing sequence performed by the imaging device 102 to determine a status of the imaging device 102. For example, the self-test print job can include an imaging device status report (e.g., to find information such as product information, connectivity settings, scan settings, etc.), a print quality diagnostic report (e.g., to determine quality of print jobs), a network configuration report (e.g., to determine network connectivity information), a facsimile test report (e.g., to determine faxing functionality), a usage report (e.g., to determine an amount of usage of the imaging device 102), and/or an event log report (e.g., to view imaging device hardware and/or system events), among other examples.

In some examples, the self-test print job can depend on the operating parameter 104-1 and the corresponding business model. For example, the self-test print job may include how many pages are left in a block subscription business model, when a next lease payment is due in a device lease business model, how much ink remains in a print material supply and when a next automatic fulfillment may occur in an automatic fulfillment business model, how many pages have been printed and/or what the fee is in a page subscription business model, among other examples.

As illustrated in FIG. 1, the imaging device 102 can be connected to an external server 112. The imaging device 102 can be connected to the external server 112 via a network relationship.

The external server 112 can provide operational information of the imaging device 102 according to the business model of the operating parameter 104-1. As used herein, the term “operational information” refers to data describing settings of the imaging device 102, the operating parameter 104-1 and/or corresponding business model, error reporting of the imaging device 102, self-test print job information, management of software and/or firmware updates for the imaging device 102, among other examples. In some examples, a user can access the operational information remotely from the imaging device 102 via a web browser through the external server 112. In some examples, a user can access the operational information locally at the imaging device 102 through the user interface 106.

As described above, in some instances, a business model may be desired for implementation on imaging device 102 that may be updated, new, and/or different from the business model associated with the operating parameter 104-1. For example, an organization may desire to lease imaging devices for at-home use by employees. The leased imaging devices may be currently in use in an office environment, may be a future acquisition, etc. In any example, a different operating parameter than the operating parameter 104-1 may be transmitted to the imaging device 102 for configuration of the imaging device 102 according to the new business model, as is further described herein.

The imaging device 102 can receive a different operating parameter 104-2 from the remote server 110. The different operating parameter 104-2 can correspond to a different business model than the operating parameter 104-1. For example, the imaging device 102 may be configured according to operating parameter 104-1 which corresponds to an automatic fulfillment business model. The imaging device 102 can receive operating parameter 104-2 from the remote server 110 which corresponds to a device lease business model.

The imaging device 102 can configure itself based on the different operating parameter 104-2 corresponding to the different business model. Continuing with the example above, the imaging device 102 can adapt its operation based on received operational parameter 104-2 so that the imaging device 102 operates when a monthly monetary fee is paid according to the device lease business model instead of according to the automatic fulfillment business model corresponding to the previous operating parameter 104-1.

The imaging device 102 can operate according to the different operating parameter 104-2 by performing an imaging device operation and/or generating a user interface based on the different operating parameter 104-2 corresponding to the business model. For example, the imaging device 102 can operate by performing an imaging device operation based on the operating parameter 104-2 corresponding to the device lease business model by performing an imaging device operation as long as the monthly monetary fee is paid. Additionally, the imaging device 102 can operate by displaying a user interface 106 on the display area of the display device 108 by displaying, for example information about the device lease business model.

Accordingly, an imaging device can be configured for many different types of business models. Operation using different types of business models can allow for flexibility with how a user and/or manufacturer approach imaging device operations. For example, a user may have more choice in imaging device selection, as well as financial and/or contractual flexibility in how they would like to approach imaging device operations. Further, a manufacturer can provide a variety of types of business models to offer users/consumers while also allowing for future business model innovation.

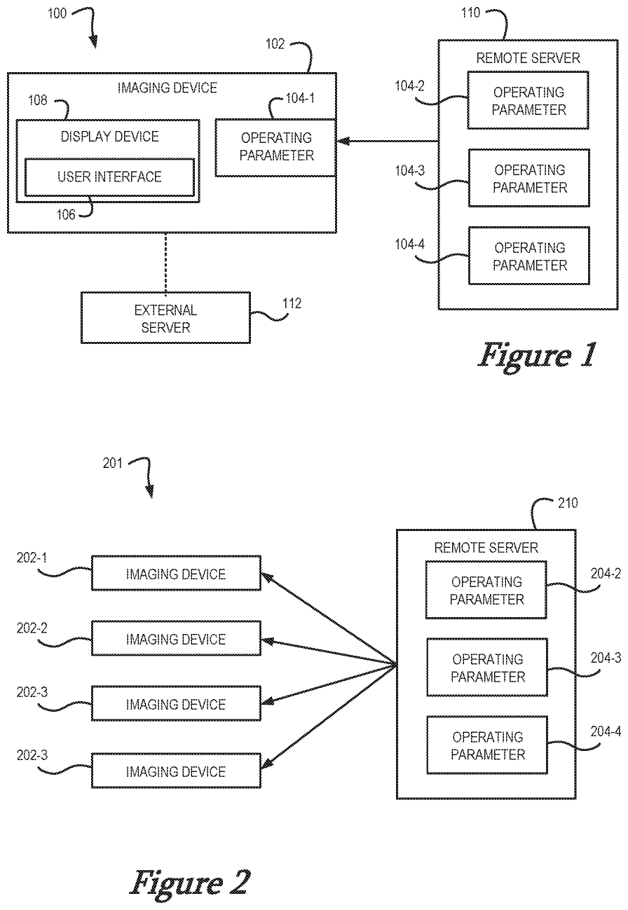

FIG. 2 is an example system of a remote server 206 and a plurality of imaging devices 202 for imaging device operations based on business models consistent with the disclosure. The system 201 can include imaging devices 202-1, 202-2, 202-3, 202-M and remote server 210.

As illustrated in FIG. 2, the remote server 210 can include a plurality of operating parameters 204-2, 204-3, 204-N. Each operating parameter 204-2, 204-3, 204-M can correspond to a particular business model. For example, operating parameter 204-2 can correspond to a supply subscription business model, operating parameter 204-3 can correspond to a page block subscription model, operating parameter 204-N can correspond to a device lease business model, etc.

The remote server 210 can transmit an operating parameter 204 to each imaging device 202. For example, the remote server 210 can transmit operating parameter 204-2 to imaging device 202-2, operating parameter 204-3 to imaging device 202-3, and/or operating parameter 204-N to imaging device 202-M.

Although the remote server 210 is described above as sending each operating parameter 204 to a different imaging device 202, examples of the disclosure are not so limited. For example, remote server 210 can send operating parameter 204-2 to imaging devices 202-2 and 202-3. In other words, the remote server 210 can send any one of the operating parameters 204 to one imaging device 202 or more than one of the imaging devices 202.

Each of the imaging devices 202 can receive the operating parameter from the remote server 210. For example, the imaging device 202-2 can receive the operating parameter 204-2 corresponding to the supply subscription business model, the imaging device 202-3 can receive the operating parameter 204-3 corresponding to the page block subscription business model, and the imaging device 202-M can receive the operating parameter 204-N corresponding to the device lease business model.

Each of the imaging devices 202 can configure themselves according to the corresponding received operating parameter. For example, imaging device 202-2 can configure itself according to the operating parameter 204-2 corresponding to the supply subscription business model, imaging device 202-3 can configure itself according to the operating parameter 204-3 corresponding to the page block subscription business model, and imaging device 202-M can configure itself according to the operating parameter 204-N corresponding to the device lease business model.

Each of the imaging devices 202 can operate according to the respective received operating parameter 204. Each of the imaging devices 202 can operate by performing an imaging device operation and/or generating a user interface based on the received operating parameters 204 corresponding to the respective business models. For example, imaging device 202-2 can operate by performing an imaging device operation and/or generating a user interface based on the received operating parameter 204-2 corresponding to the supply subscription business model, imaging device 202-3 can operate by performing an imaging device operation and/or generating a user interface based on the received operating parameter 204-3 corresponding to the page block subscription business model, and imaging device 202-M can operate by performing an imaging device operation and/or generating a user interface based on the received operating parameter 204-N corresponding to the device lease business model.

As described above, imaging devices 202-2, 202-3, 202-M can perform imaging device operations according to their respective received operating parameters 204 as long as the imaging devices 202 are in compliance with each of their respective business models. For example, the remote server 210 can determine compliance for each of the imaging devices 202. For instance, the remote server 210 can determine whether a recurring fee has been paid for the supply subscription business model having the operating parameter 204-2 for the imaging device 202-2. Additionally, the remote server 210 can determine whether a block of pages has been purchased and available for the page block subscription business model having the operating parameter 204-3 for the imaging device 202-3. Further, the remote server 210 can determine whether a fee has been paid for the specified period of use for the device lease business model having the operating parameter 204-N for the imaging device 202-M.

The remote server 210 can determine the compliance of each of the imaging devices 202 at a predetermined frequency. The predetermined frequency can be based on the operating parameter and the corresponding business model.

Although the imaging devices 202-2, 202-3, 202-M are described above as having received operating parameter 204-2 corresponding to a supply subscription business model, operating parameter 204-3 corresponding to a page block subscription business model, and operating parameter 204-N corresponding to a device lease business model, examples of the disclosure are not so limited. For example, operating parameters 204-2, 204-3, 204-N can correspond to any other business model (e.g., supply subscription, supply loyalty, page block, automatic fulfillment, device lease, page subscription etc.) and imaging devices 202-1, 202-2, 202-3, 202-M can receive any of the operating parameters 204.

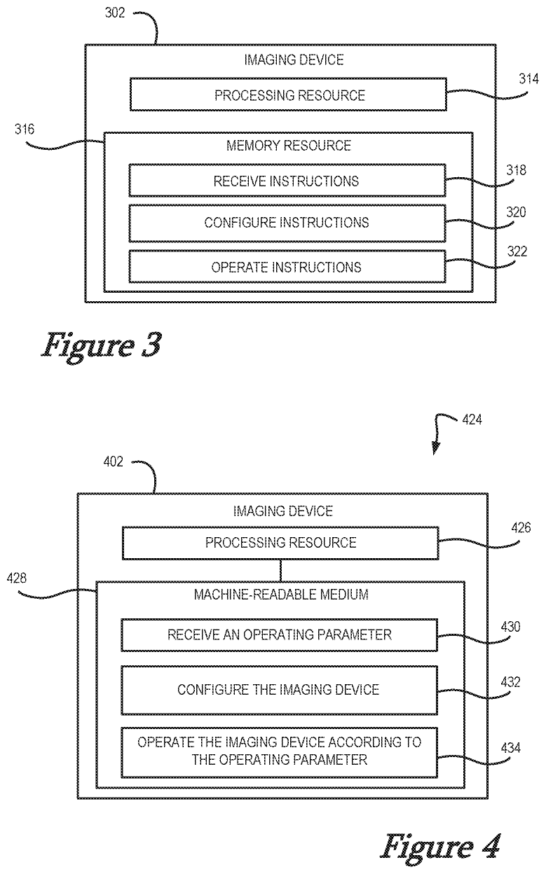

FIG. 3 is a diagram of an example imaging device 302 for imaging device operations based on business models consistent with the disclosure. As described herein, the imaging device 302 may perform functions related to imaging device operations based on business models. Although not illustrated in FIG. 3, the imaging device 302 may include a processor and a machine-readable storage medium. Although the following descriptions refer to a single processor and a single machine-readable storage medium, the descriptions may also apply to a system with multiple processors and multiple machine-readable storage mediums. In such examples, the imaging device 302 may be distributed across multiple machine-readable storage mediums and across multiple processors. Put another way, the instructions executed by the imaging device 302 may be stored across multiple machine-readable storage mediums and executed across multiple processors, such as in a distributed or virtual computing environment.

Processing resource 314 may be a central processing unit (CPU), a semiconductor-based microprocessor, and/or other hardware devices suitable for retrieval and execution of machine-readable instructions 318, 320, 322 stored in a memory resource 316. Processing resource 314 may fetch, decode, and execute instructions 318, 320, 322. As an alternative or in addition to retrieving and executing instructions 318, 320, 322, processing resource 314 may include a plurality of electronic circuits that include electronic components for performing the functionality of instructions 318, 320, 322.

Memory resource 316 may be any electronic, magnetic, optical, or other physical storage device that stores executable instructions 318, 320, 322, and/or data. Thus, memory resource 316 may be, for example, Random Access Memory (RAM), an Electrically-Erasable Programmable Read-Only Memory (EEPROM), a storage drive, an optical disc, and the like. Memory resource 316 may be disposed within imaging device 302, as shown in FIG. 3. Additionally, memory resource 316 may be a portable, external or remote storage medium, for example, that causes imaging device 302 to download the instructions 318, 320, 322 from the portable/external/remote storage medium.

The imaging device 302 may include instructions 318 stored in the memory resource 316 and executable by the processing resource 314 to receive an operating parameter corresponding to a business model. For example, the imaging device 302 can receive an operating parameter corresponding to a device lease business model. The imaging device 302 can receive the operating parameter from a remote server.

The imaging device 302 may include instructions 320 stored in the memory resource 316 and executable by the processing resource 314 to configure the imaging device based on the received operating parameter corresponding to the business model. For example, the imaging device 302 can configure itself according to the operating parameter corresponding to the device lease business model.

The imaging device 302 may include instructions 322 stored in the memory resource 316 and executable by the processing resource 314 to operate the imaging device 302 according to the received operating parameter. For example, the imaging device 302 can operate according to the received operating parameter corresponding to the device lease business model. The imaging device 302 can operate by performing an imaging device operation based on the operating parameter corresponding to the device lease business model and/or generate a user interface based on the operating parameter corresponding tot eh device lease business model, among other examples of received operating parameters that correspond to other various business models.

FIG. 4 is a block diagram of an example system 424 for imaging device operations based on business models consistent with the disclosure. In the example of FIG. 4, system 424 includes a processing resource 426 and a non-transitory machine-readable storage medium 428. Although the following descriptions refer to a single processing resource and a single machine-readable storage medium, the descriptions may also apply to a system with multiple processors and multiple machine-readable storage mediums. In such examples, the instructions may be distributed across multiple machine-readable storage mediums and the instructions may be distributed across multiple processors. Put another way, the instructions may be stored across multiple machine-readable storage mediums and executed across multiple processors, such as in a distributed computing environment.

Processing resource 426 may be a central processing unit (CPU), microprocessor, and/or other hardware device suitable for retrieval and execution of instructions stored in machine-readable storage medium 428. In the particular example shown in FIG. 4, processing resource 426 may receive, determine, and send instructions 430, 432, and 434. As an alternative or in addition to retrieving and executing instructions, processing resource 426 may include an electronic circuit comprising a number of electronic components for performing the operations of the instructions in machine-readable storage medium 428. With respect to the executable instruction representations or boxes described and shown herein, it should be understood that part or all of the executable instructions and/or electronic circuits included within one box may be included in a different box shown in the figures or in a different box not shown.

Machine-readable storage medium 428 may be any electronic, magnetic, optical, or other physical storage device that stores executable instructions. Thus, machine-readable storage medium 428 may be, for example, Random Access Memory (RAM), an Electrically-Erasable Programmable Read-Only Memory (EEPROM), a storage drive, an optical disc, and the like. The executable instructions may be “installed” on the system 424 illustrated in FIG. 4. Machine-readable storage medium 428 may be a portable, external or remote storage medium, for example, that allows the system 424 to download the instructions from the portable/external/remote storage medium. In this situation, the executable instructions may be part of an “installation package”. As described herein, machine-readable storage medium 428 may be encoded with executable instructions associated with imaging device operations based on business models.

Receive an operating parameter instructions 430, when executed by a processor such as processing resource 426, may cause system 424 to receive an operating parameter corresponding to a business model. The operating parameter can be received by the imaging device 402 from a remote server.

Configure the imaging device instructions 432, when executed by a processor such as processing resource 426, may cause system 424 to configure the imaging device 402 based on the received operating parameter corresponding to the business model.

Operate the imaging device according to the operating parameter instructions 434, when executed by a processor such as processing resource 426, may cause system 424 to operate the imaging device 402 according to the received operating parameter. The imaging device 402 can operate by performing an imaging device operation based on the operating parameter corresponding to the business model in response to the imaging device 402 being in compliance with the business model, and/or generating a user interface based on the operating parameter corresponding to the business model for display on a display device.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” can refer to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 202 in FIG. 2. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense. As used herein, the designators “N” and “M”, particularly with respect to reference numerals in the drawings, indicates that a number of the particular feature so designated can be included with examples of the present disclosure.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

What is claimed is:

1. An imaging device, comprising:
a processing resource; and
a memory resource storing non-transitory machine-readable instructions to cause the processing resource to:
receive an operating parameter corresponding to a business model; and
configure the imaging device based on the received operating parameter corresponding to the business model; and
operate the imaging device according to the received operating parameter by at least one of:
performing an imaging device operation based on the operating parameter corresponding to the business model; and
generating a user interface based on the operating parameter corresponding to the business model.

2. The imaging device of claim 1, wherein the imaging device operation includes at least one of:
a print job;
a scan job;
a copy job; and
a facsimile job.

3. The imaging device of claim 1, wherein:
the imaging device further includes a display device;
the processing resource is to cause the display device to display the user interface corresponding to the business model.

4. The imaging device of claim 3, wherein the user interface includes settings of the imaging device.

5. The imaging device of claim 3, wherein the user interface includes error reporting of the imaging device in response to an error occurring in the imaging device.

6. The imaging device of claim 1, wherein:
the imaging device is connected to an external server; and
the external server is to provide operational information of the imaging device according to the business model.

7. The imaging device of claim 1, wherein the processing resource is to further operate the imaging device by performing a self-test print job.

8. A non-transitory machine-readable medium including instructions that when executed cause a processing resource to:
receive an operating parameter corresponding to a business model; and
configure the imaging device based on the received operating parameter corresponding to the business model; and
operate the imaging device according to the received operating parameter by at least one of:
performing an imaging device operation based on the operating parameter corresponding to the business model in response to the imaging device being in compliance with the business model; and
generating a user interface based on the operating parameter corresponding to the business model for display on a display device.

9. The medium of claim 8, wherein the processing resource is to receive a different operating parameter corresponding to a different business model.

10. The medium of claim 9, wherein the processing resource is to configure the imaging device based on the different operating parameter.

11. The medium of claim 10, wherein the processing resource is to operate the imaging device according to the different operating parameter corresponding to the different business model by at least one of:
performing a different imaging device operation based on the different operating parameter; and
providing a different user interface corresponding to the different business model.

12. A system, comprising:
a remote server including a plurality of operating parameters each corresponding to a business model of a plurality of business models;
a plurality of imaging devices, wherein each of the plurality of imaging devices are to:
receive, from the remote server, an operating parameter corresponding to a business model of the plurality of business models;
configure each imaging device according to the corresponding received operating parameter; and
operate according to the respective received operating parameter by generating a user interface corresponding to the respective received operating parameter.

13. The system of claim 12, wherein the remote server is to determine, for each imaging device of the plurality of imaging devices, compliance with each of their respective business models.

14. The system of claim 13, wherein the remote server is to determine the compliance at a predetermined frequency.

15. The system of claim 12, wherein the remote server is to transmit the operating parameter to each of the plurality of imaging devices as software.
